(19) United States
(12) Patent Application Publication
(10) Pub. No.: US 2024/0131971 A1
(43) Pub. Date: Apr. 25, 2024

(54) HEADREST AIR-CONDITIONING DEVICE FOR VEHICLES

(71) Applicant: SEOYON E-HWA CO., LTD., Anyang (KR)

(72) Inventor: Hyun Jun PARK, Seoul (KR)

(21) Appl. No.: 18/487,046

(22) Filed: Oct. 13, 2023

(30) Foreign Application Priority Data
Oct. 24, 2022 (KR) 10-2022-0138262

(51) Int. Cl. B60N 2/56; B60H 1/22

(52) U.S. Cl. CPC B60N 2/5642; B60H 1/2225; B60H 2001/2293

(57) ABSTRACT

Disclosed herein is a headrest air-conditioning device for vehicles, wherein a heater plate with planar heating elements on both sides thereof is installed inside a casing, and the heater plate divides the interior space of the casing to form an inflow passage and an outflow passage. Accordingly, it is possible to effectively heat air with low power and to reduce flow resistance and thus power consumption.

### BACKGROUND

### 1. Technical Field

The present disclosure relates to a headrest air-conditioning device for vehicles, and more particularly, to a headrest air-conditioning device for vehicles, which is provided inside a headrest to supply air-conditioned wind to an occupant's neck and shoulders.

### 2. Related Art

A vehicle is equipped with an air-conditioning system to supply cold air and warm air to the interior space thereof.

The above air-conditioned wind is mainly discharged to the interior space through vent grilles provided on an instrument panel, a center console, a pillar, and the like at the front of the interior. The plurality of vent grills are connected to the air-conditioning system installed inside the instrument panel through respective ducts, and the air-conditioning system may include a cooler and a heater therein to generate cold air and warm air.

Meanwhile, the conventional air-conditioning system as described above operates for the entire interior space of the vehicle and mainly discharges air-conditioned air to the front of the body including an occupant's face, which may cause discomfort to occupants who do not want the air-conditioned air.

Accordingly, although the vent grills have air volume and direction control means for changing or blocking the direction of air-conditioned wind for each individual occupant, it was difficult to completely block the influence of air-conditioned wind from all the vent grills.

Hence, an air-conditioning device has been developed to achieve a cooling effect by individually blowing air to an occupant's neck and shoulders that are sensitive to the influence of cold and warm air and to supply additional warm air. This individual air-conditioning device may be equipped with an electric heating device and a fan inside a headrest or an upper portion of a seat back to discharge room temperature air and warm air (heating air) to the occupant's neck and shoulders.

However, the above individual air-conditioning device may consume a lot of power because it generates warm air by passing air through the heating device that uses electric resistance heating wires. This is emerging as a bigger issue in electric vehicles in which battery power consumption is directly related to the mileage of the vehicles.

In addition, since the air-conditioned wind is discharged in a horizontal direction from rear to front toward the back of the occupant's neck (close to the ears), it may cause discomfort to the occupant due to fan operating noise and discharge noise of air-conditioned wind when the air-conditioning device is in operation.

The foregoing is intended for technical information possessed for derivation of the present disclosure or acquired in the process of derivation thereof by the inventor, which is not necessarily a known technique disclosed to the general public prior to the filing of the invention.

### PATENT DOCUMENT

(Patent Document 1) Japanese Patent Application Publication No. 2007-519563 (Jul. 19, 2007)

### SUMMARY

Various embodiments are directed to a headrest air-conditioning device for vehicles that is capable of reducing power consumption and operating noise, which is advantageous for extending the mileage of electric vehicles and provides a quieter feeling of use for occupants.

The present disclosure is not limited to the above-mentioned object, and other objects of the present disclosure will be clearly understood by those skilled in the art to which the present disclosure pertains from the following description.

In accordance with an aspect of the present disclosure, there is provided a headrest air-conditioning device for vehicles, which includes a casing installed inside a headrest, a heater plate installed inside the casing and having planar heating elements provided on sides thereof, an inflow passage and an outflow passage formed by dividing an internal space of the casing by the heater plate, and a fan installed in a connection space between the inflow passage and the outflow passage.

The inflow passage may be formed vertically at the rear of the casing, the outflow passage may be formed vertically at the front of the casing, the connection space between the inflow passage and the outflow passage may be defined in an upper portion of the casing, and an inlet of the inflow passage and an outlet of the outflow passage may be formed on a lower surface of the headrest.

In the headrest air-conditioning device according to the present disclosure, the planar heating elements may be provided on both sides of the heater plate, and heat conductive plates may be installed on respective walls facing both the planar heating elements in the inflow passage and the outflow passage.

In the headrest air-conditioning device according to the present disclosure, a front inner surface of an outlet of the outflow passage may be formed as a Coanda curved surface that serves to guide discharged air to an occupant's neck and shoulders.

In the headrest air-conditioning device according to the present disclosure, the heater plate may consist of a plurality of heater plates installed at regular intervals in a front-and-rear direction of the casing to increase the number of passages, narrow a spacing between passages, and increase the number of heating surfaces.

In the headrest air-conditioning device according to the present disclosure, the heater plate may have a plurality of backflow holes for allowing air to flow backward from downstream to upstream in a direction of flow thereof.

In the headrest air-conditioning device according to the present disclosure, the headrest air-conditioning device may further include an outer casing surrounding the casing, a Helmholtz chamber may be formed between the casing and the outer casing, and the casing may have a plurality of Helmholtz holes formed on its front surface to allow the Helmholtz chamber to communicate with the outflow passage.

The Helmholtz chamber may be a single sealed space connecting the inner front and both sides of the outer casing.

In the headrest air-conditioning device according to the present disclosure, the casing may have a plurality of noise emission holes formed on its rear surface, and the outer casing may have a plurality of opening holes formed on its rear surface, so that noise within the casing is absorbed into a headrest cushion surrounding the outer casing through the noise emission holes and the opening holes.

In the headrest air-conditioning device according to the present disclosure, the casing may be divided into a front casing and a rear casing.

In the headrest air-conditioning device according to the present disclosure, the rear casing may have an intermediate part formed in its lower inner portion to partition an inlet of the inflow passage and an outlet of the outflow passage, and the intermediate part may support a lower end of the heater plate.

In the headrest air-conditioning device according to the present disclosure, the intermediate part may have a plurality of partition walls formed in a width direction of the rear casing, and the lower end of the heater plate may be supported by the partition walls.

As is apparent from the above description, the headrest air-conditioning device for vehicles according to the present disclosure uses the planar heating elements as air heating sources to reduce power consumption compared to the existing heating device with electric resistance heating wires.

In addition, in the headrest air-conditioning device for vehicles according to the present disclosure, the inside of the headrest is divided into the inflow passage and the outflow passage by the heater plate, and the planar heating elements are provided on both sides of the heater plate. Thus, as air is heat exchanged twice, the amount of heat exchange is increased and the heating performance of the air is improved.

In addition, the headrest air-conditioning device for vehicles according to the present disclosure reduces the amount of noise transmitted to the occupant since the outlet of the outflow passage is formed downward of the headrest.

In addition, the headrest air-conditioning device for vehicles according to the present disclosure uses the planar heating elements as heating sources to reduce air flow resistance and thus noise.

In addition, the headrest air-conditioning device for vehicles according to the present disclosure reduces air flow resistance and thus air volume loss to reduce the amount of fan rotation, which not only reduces power consumption but also reduces noise.

In addition, in the headrest air-conditioning device for vehicles according to the present disclosure, since the Coanda surface is formed toward the occupant's neck and shoulders at the outlet of the outflow passage, the air-conditioned wind is more accurately supplied toward the occupant's neck and shoulders.

In addition, in the headrest air-conditioning device for vehicles according to the present disclosure, the Helmholtz chamber (Helmholtz resonator) is formed between the casing and the outer casing of the air-conditioning device to absorb and reduce noise generated when the air-conditioning device operates.

Furthermore, the headrest air-conditioning device for vehicles according to the present disclosure reduces noise by forming the noise emission holes in the casing and the outer casing to absorb the noise into the headrest cushion.

The present disclosure is not limited to the above-mentioned effects, and other effects of the present disclosure will be clearly understood by those skilled in the art to which the present disclosure pertains from the following description.

### BRIEF DESCRIPTION OF THE DRAWINGS

FIG. 1 is a view illustrating a schematic installation state and side cross-section of a headrest air-conditioning device for vehicles according to a first embodiment of the present disclosure.

FIG. 2 is a side cross-sectional view schematically illustrating a headrest air-conditioning device for vehicles according to a second embodiment of the present disclosure.

FIG. 3 is a cross-sectional view taken along line III-III of FIG. 2, when viewing the headrest air-conditioning device for vehicles according to the second embodiment from the front.

FIG. 4 is an exploded view illustrating the headrest air-conditioning device for vehicles in FIG. 2 with a headrest cushion excluded therefrom.

FIG. 5 is a rear view illustrating the headrest air-conditioning device for vehicles in FIG. 2 with the headrest cushion excluded therefrom.

### DETAILED DESCRIPTION

The accompanying drawings in the present disclosure may have been exaggerated for differentiation and clarity from the prior art and for the sake of understanding the technology. In addition, the terms used in the specification are terms defined in consideration of functions of the present disclosure, and these terms may change depending on the intention or practice of a user or an operator. Therefore, these terms should be defined based on the overall disclosures set forth herein. Meanwhile, the following embodiments are merely for the purpose of describing the components set forth in the appended claims and are not intended to limit the spirit and scope of the disclosure.

Throughout the specification, it will be understood that, when a component is referred to as “comprising” or “including” any component, it does not exclude other components, but can further comprise or include the other components unless otherwise specified.

In addition, it will be understood that, when a component is referred to as being “connected”, “joined”, or “coupled” to another component, it can be “directly connected”, “directly joined”, or “directly coupled” to the other component or it can be “indirectly connected”, “indirectly joined”, or “indirectly coupled” to the other component with other components being interposed therebetween. On the other hand, it will be understood that, when a component is referred to as being “directly connected”, “directly joined”, or “directly coupled” to another component, no intervening components are present.

In addition, when directional terms such as “before”, “after”, “up”, “down”, “left”, “right”, “one end”, “other end”, and both ends” are used, these terms should not be construed as limiting as they are used by way of example in relation to the orientation in the drawings disclosed herein. As used herein, the terms such as “first” and “second” should not be construed as limiting terms for distinguishing each component.

In order to more clearly describe features of embodiments of the present disclosure, a detailed description of matters widely known to those skilled in the art to which the following embodiments pertain will be omitted. In addition, a detailed description of parts irrelevant to the embodiment and description in the drawings will be omitted.

Hereinafter, exemplary embodiments of the present disclosure will be described in detail with reference to the accompanying drawings.

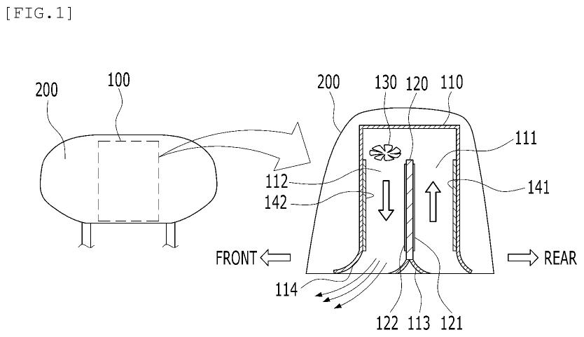

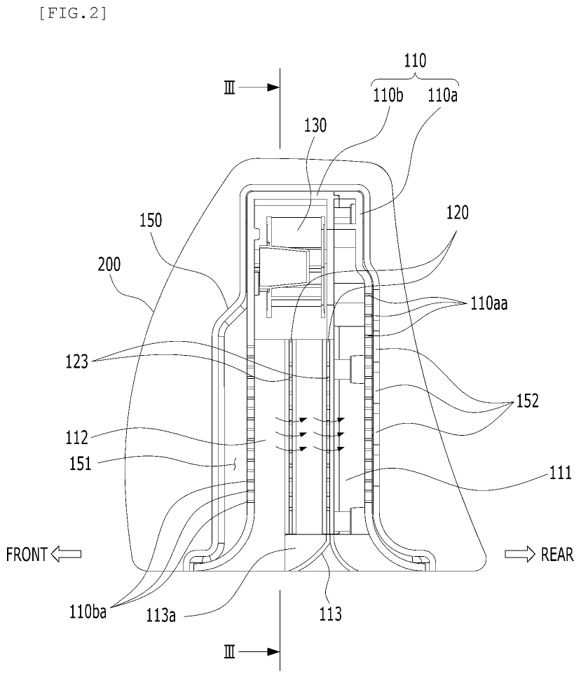

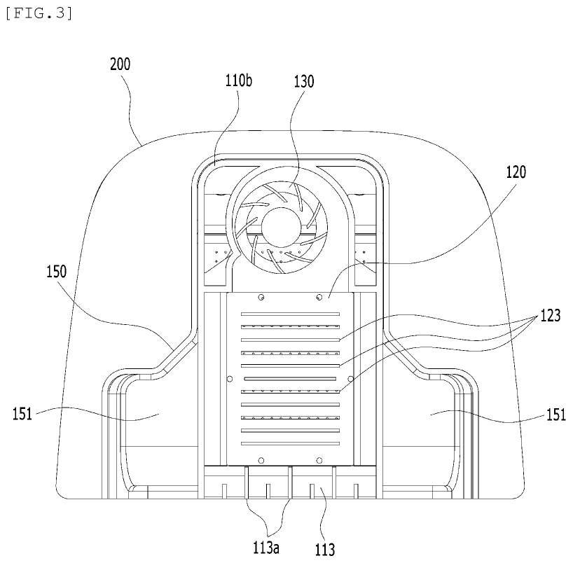

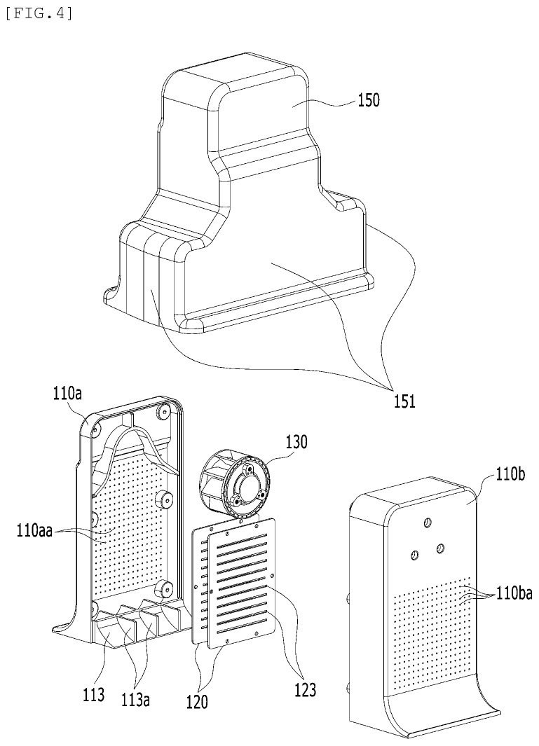

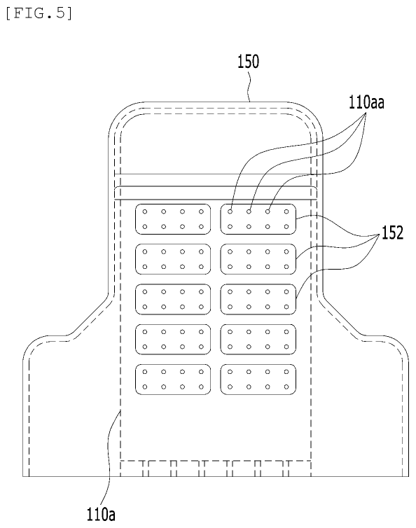

FIG. 1 is a view illustrating a schematic installation state and side cross-section of a headrest air-conditioning device for vehicles according to a first embodiment of the present disclosure. FIG. 2 is a side cross-sectional view schematically illustrating a headrest air-conditioning device for vehicles according to a second embodiment of the present disclosure. FIG. 3 is a cross-sectional view taken along line III-III of FIG. 2, when viewing the headrest air-conditioning device for vehicles according to the second embodiment from the front. FIG. 4 is an exploded view illustrating the headrest air-conditioning device for vehicles in FIG. 2 with a headrest cushion excluded therefrom. FIG. 5 is a rear view illustrating the headrest air-conditioning device for vehicles in FIG. 2 with the headrest cushion excluded therefrom.

Referring to FIG. 1, the headrest air-conditioning device for vehicles, which is designated by reference numeral 100, according to the first embodiment of the present disclosure includes a casing 110, a heater plate 120, an inflow passage 111, an outflow passage 112, and a fan 130.

The casing 110 is roughly in the shape of a box with an open bottom. The casing 110 is installed inside a headrest, more specifically, inside a headrest cushion 200, and defines a passage formation space and an installation space for the fan 130.

The heater plate 120 is installed vertically, namely, in an upright position, at the inner center of the casing 110 in the front-and-rear direction thereof, and divides the internal space of the casing 110 into a front space and a rear space. In this case, the upper portions of the respective front and rear spaces are connected to each other, and the lower portions thereof are open downward of the headrest cushion 200. Here, the rear space becomes the inflow passage 111 through which air is introduced, and the front space becomes the outflow passage 112 through which air is discharged. That is, the inflow passage 111 and the outflow passage 112 are formed by dividing the internal space of the casing 110 by the heater plate 120. The inflow passage 111 is formed vertically at the rear of the casing 110, and the outflow passage 112 is formed vertically at the front of the casing 110. The connection space between the inflow passage 111 and the outflow passage 112 is defined in the upper portion of the casing 110.

In the lower portion of the casing 110, the inlet of the inflow passage 111 and the outlet of the outflow passage 112 are formed and communicate with the interior space through the lower surface of the headrest. That is, the inlet of the inflow passage 111 and the outlet of the outflow passage 112 are formed on the lower surface of the headrest.

An intermediate part 113 is formed between the inlet of the inflow passage 111 and the outlet of the outflow passage 112 to separate them. The lower end of the heater plate 120 may be supported by the intermediate part 113. The rear and front surfaces of the intermediate part 113 may be formed with the same curved shape as the walls of the inlet of the inflow passage 111 and the outlet of the outflow passage 112 facing each other to facilitate smooth introduction and discharge of air.

In particular, the front inner wall (inner surface) of the outlet of the outflow passage 112 is formed as a Coanda curved surface 114 that guides the direction of discharged air toward an occupant's neck and shoulders. The Coanda curved surface 114 refers to a surface that guides the direction of flow of fluid in the direction of curvature of that curved surface due to the Coanda Effect (a phenomenon in which fluid flows along a curved surface due to viscosity).

The heater plate 120 has planar heating elements 121 and 122 provided on the respective rear and front surfaces thereof. These planar heating elements 121 and 122 are formed by applying a conductive paste containing at least one of carbon nano tube (CNT), poly-cyclohexylene dimethylene terephthalate (PCT), and conductive metal powder to the surface of the heater plate 120. In addition, each of the planar heating elements 121 and 122 includes an electrode and a wire connected to the electrode for supply of current, but since this configuration is very common, an illustration and description thereof will be omitted.

Heat conductive plates 141 and 142 are attached to the inner surfaces of the casing 110 facing the planar heating elements 121 and 122, respectively. That is, the heat conductive plates 141 and 142 are installed on the walls facing both the planar heating elements 121 and 122 in the inflow passage 111 and the outflow passage 112, respectively. The heat conductive plates 141 and 142 are sheets made of a metal material with excellent thermal conductivity, such as aluminum, for example. The heat conductive plates 141 and 142 are heated by the radiant heat of the planar heating elements 121 and 122 to emit radiant heat into the passage spaces, and transfers conductive heat to the air in contact therewith.

The fan 130 is installed on the inner upper side of the casing 110, namely, on one side of the connection space between the inflow passage 111 and the outflow passage 112. The fan 130 is driven to rotate by a motor, and the motor and a power supply line connected to the motor are not omitted.

With the above configuration, the headrest air-conditioning for vehicles 100 according to the first embodiment of the present disclosure may drive the fan 130 to suck air from the vehicle interior into the inflow passage 111 and then discharge the air through the outflow passage 112, thereby blowing the air to the occupant's neck (more precisely, the lower part of the neck) and shoulders. Therefore, when the room temperature is not so high, the headrest air-conditioning device may be used like a regular fan to provide a feeling of coolness through a simple blowing function. In addition, when the vehicle interior is cooled, cold air is sucked from the interior and discharged, thereby intensively supplying the cold air to the occupant's neck and shoulders and providing a feeling of more coolness.

Meanwhile, when the planar heating elements 121 and 122 of the heater plate 120 are operated, heat is generated on both sides of the heater plate 120 and is radiated to the spaces, namely, the inflow passage 111 and the outflow passage 112.

The radiant heat of the planar heating elements 121 and 122 is transferred to the heat conductive plates 141 and 142 at opposing positions and is conducted and accumulated within the heat conductive plates 141 and 142, thereby heating the heat conductive plates 141 and 142. Radiant heat is also emitted from the heated heat conductive plates 141 and 142 to the inflow passage 111 and the outflow passage 112.

Thus, the air sucked into the inlet of the inflow passage 111 is primarily heated by absorbing radiant heat from one side of the heater plate 120 and the heat conductive plate 141 facing the same while flowing through the inflow passage 111. In this case, one side of the heater plate 120 and the heat conductive plate 141 may conduct heat with the air flowing in contact therewith.

The air primarily heated as described above is secondarily heated through radiation and conduction by passing through the fan 130 and then passing between the other side of the heater plate 120 and the heat conductive plate 142 facing the same while moving down through the outflow passage 112. Even in this case, the other side of the heater plate 120 and the heat conductive plate 142 may conduct heat with the air flowing in contact therewith.

In addition, air is subjected to convective heat transfer due to the difference in passage temperature while passing through the inflow passage 111 and the outflow passage 112, thereby enabling the air to be increased in temperature therethrough the flow.

The air increased in temperature through the primary and secondary heating processes as described above is discharged through the outlet and supplied to the occupant's neck and shoulders, thereby allowing the occupant to feel the warmth caused by the heating air.

As described above, the headrest air-conditioning device for vehicles 100 according to the first embodiment of the present disclosure uses the planar heating elements 121 and 122 to reduce power consumption compared to the existing electric resistance heating wire (assuming the amount of heat generated is the same, a planar heating element consumes less power than an electric resistance heating wire).

As air moves up and down the path from bottom to top of the headrest, the air is heated during the long path and is heated by the heat transferred from both sides of the passage during movement. In addition, the air may be heated efficiently while consuming less power since heat is generated on both sides of the passage (planar heating).

In addition, since heat is transferred from both sides of the passage to the space and there are no parts that generate flow resistance in the passage space, the flow resistance of the air passing through the passage is very small, thereby reducing the rotational speed of the fan 130 serving to suck and discharge air and reducing power consumption.

As the power consumption for heating and moving air is reduced as described above, when the headrest air-conditioning device 100 according to the first embodiment of the present disclosure is applied to an electric vehicle, battery power usage is reduced, which may increase the mileage of the vehicle.

Meanwhile, the headrest air-conditioning device for vehicles 100 according to the first embodiment of the present disclosure is located on the lower surface of the headrest where the inlet and outlet of air are far away from the occupant's ears and the discharge direction of air is also inclined downward, so that the air is gradually discharged in a direction away from the ears. Therefore, the noise felt by the occupant during suction and discharge of air is reduced.

In addition, in the headrest air-conditioning device for vehicles 100 according to the first embodiment of the present disclosure, the rotation speed of the fan 130 may be reduced as described above and the operating noise of the fan 130 may thus be reduced.

As described above, the headrest air-conditioning device for vehicles 100 according to the first embodiment of the present disclosure has the effect of reducing power consumption and noise.

In addition, the headrest air-conditioning device for vehicles 100 according to the first embodiment of the present disclosure has the effect of precisely guiding the discharge direction of toward the occupant's neck and shoulders since the Coanda curved surface 114 is formed at the front of the outlet of the outflow passage 112.

Hereinafter, the headrest air-conditioning device for vehicles, which is designated by reference numeral 100, according to the second embodiment of the present disclosure will be described with reference to FIGS. 2 to 5. The same description as the headrest air-conditioning device 100 according to the first embodiment of the present disclosure illustrated in FIG. 1 will be omitted. In particular, as with the first embodiment, the casing 110 is installed inside the headrest cushion 200 and the heater plate 120 and the fan 130 are installed inside the casing 110.

In the headrest air-conditioning device 100 according to the second embodiment of the present disclosure, the heater plate 120 may consist of plurality of heater plates. In addition to the basic heater plate 120 for separating the inflow passage 111 and the outflow passage 112, the heater plate 120 additionally installed includes, of course, planar heating elements 121 and 122 provided on both sides thereof. The additional heater plate 120 may be installed in the inflow passage 111 and/or the outflow passage 112. FIG. 2 illustrates an example in which the heater plate 120 is additionally installed in the outflow passage 112.

The additional heater plate 120 may be supported at the lower end thereof by partition walls 113a formed at regular intervals longitudinally at the intermediate part 113.

As the additional heater plate 120 is installed as described above, that is, as the plurality of heater plates 120 are installed at regular intervals in the front-and-rear direction of the casing 110, the heater plates 120 separate the space to increase the number of passages, so that the spacing between the passages narrows and the number of heating surfaces increases. Thus, the amount of air passing through each individual passage decreases and the amount of heat applied to each individual passage increases, thereby making it possible to heat air more quickly. In other words, air heating performance is improved.

In addition, each of the heater plates 120 has a plurality of backflow holes 123 formed therein. The backflow holes 123 are horizontally elongated straight holes and are formed at regular intervals vertically. The backflow holes 123 allow air to flow backward from downstream to upstream in the direction of flow thereof. That is, the backflow may occur from the outflow passage 112 to the inflow passage 111. Thus, as the air flowing backward may be further heated while flowing through the passage again, it is possible to increase the air to a higher temperature more easily. In other words, air heating performance is improved.

Meanwhile, the headrest air-conditioning device 100 may further include an outer casing 150 surrounding the casing 110. A Helmholtz chamber (Helmholtz resonator) 151 is formed between the outer casing 150 and the casing 110. The Helmholtz chamber 151 is an empty space connecting the inner front and both sides of the outer casing 150, is sealed against the outside, and communicates with the outflow passage 112 through a Helmholtz hole 110ba formed on the front surface of the casing 110.

The Helmholtz hole 110ba is a small-sized (about 1.0 to 2.0 mm inner diameter) through-hole formed on the front surface of the casing 110, and consists of a plurality of Helmholtz holes 110ba formed in a portion corresponding to the area of the Helmholtz chamber 151. Here, the diameter and number of Helmholtz holes 110ba and the shape and volume of the Helmholtz chamber 151 are designed to effectively reduce the noise of the outflow passage 112 through preliminary repeated experiments.

Accordingly, the air flow noise and fan operating noise in the outflow passage 112 are absorbed into the Helmholtz chamber 151 through the Helmholtz holes 110ba and discharged to the outside of the headrest, thereby reducing the noise transmitted to the occupant.

In addition, the casing 110 has a plurality of noise emission holes 110aa formed on the rear surface thereof, and the outer casing 150 has a plurality of approximately rectangular opening holes 152 formed at regular intervals on the rear surface thereof as illustrated in FIG. 5. Each of the noise emission holes 110aa is a through-hole with a small diameter like the Helmholtz holes 110ba. Accordingly, the plurality of noise emission holes 110aa exist within the area of one opening hole 152.

The rear surface of the casing 110 is in close contact with the rear surface of the outer casing 150, and the outer casing 150 is surrounded by the headrest cushion 200.

Accordingly, the air flow noise in the inflow passage 111 is absorbed by the headrest cushion 200 through the noise emission holes 110aa and the opening holes 152, thereby reducing noise. In other words, the cushion material (polyurethane foam) of the headrest acts as a sound absorber and reduces noise.

Meanwhile, the casing 110 may be divided into a rear casing 110a forming the rear thereof and a front casing 110b forming the front thereof. The intermediate part 113 may be formed in the lower inner portion of the rear casing 110a and supports the lower end of each heater plate 120 as described above. More specifically, the plurality of partition walls 113a are formed in the width direction of the rear casing 110a at the intermediate part 113, and the lower end of the heater plate 120 is supported by the partition walls 113a.

Since the casing 110 is divided into the rear casing 110a and the front casing 110b as described above, the heater plate 120 and the fan 130 may be easily installed inside the casing 110.

As described above, the headrest air-conditioning device for vehicles according to the present disclosure uses the planar heating elements as air heating sources to reduce power consumption compared to the existing heating device with electric resistance heating wires. The inside of the headrest is divided into the inflow passage and the outflow passage by the heater plate, and the planar heating elements are provided on both sides of the heater plate. Thus, as air is heat exchanged twice, the amount of heat exchange is increased and the heating performance of the air is improved. The outlet of the outflow passage is formed downward of the headrest, which reduces the amount of noise transmitted to the occupant. The planar heating elements are used as heating sources to reduce air flow resistance and thus noise. Air flow resistance and thus air volume loss are reduced to reduce the amount of fan rotation, which not only reduces power consumption but also reduces noise. Since the Coanda surface is formed toward the occupant's neck and shoulders at the outlet of the outflow passage, the air-conditioned wind is more accurately supplied toward the occupant's neck and shoulders. The Helmholtz chamber (Helmholtz resonator) is formed between the casing and the outer casing of the air-conditioning device to absorb and reduce noise generated when the air-conditioning device operates. Noise is reduced by forming the noise emission holes in the casing and the outer casing to absorb the noise into the headrest cushion.

The present disclosure relates to a headrest air-conditioning device for vehicles, which can be used in industrial applications related to headrests for vehicle seats.

While the present disclosure has been described with respect to the embodiments illustrated in the drawings, it will be obvious to those skilled in the art that such embodiments are provided by way of example only. It will be understood by those skilled in the art that various modifications and other equivalent embodiments may be made without departing from the spirit and scope of the disclosure as defined in the following claims. Therefore, the true technical protection scope of the present disclosure should be defined by technical concepts of the appended claims.

What is claimed is:

1. A headrest air-conditioning device for vehicles, comprising:
a casing installed inside a headrest;
a heater plate installed inside the casing and having planar heating elements provided on sides thereof;
an inflow passage and an outflow passage formed by dividing an internal space of the casing by the heater plate; and
a fan installed in a connection space between the inflow passage and the outflow passage.

2. The headrest air-conditioning device according to claim 1, wherein the inflow passage is formed vertically at the rear of the casing, the outflow passage is formed vertically at the front of the casing, the connection space between the inflow passage and the outflow passage is defined in an upper portion of the casing, and an inlet of the inflow passage and an outlet of the outflow passage are formed on a lower surface of the headrest.

3. The headrest air-conditioning device according to claim 1, wherein the planar heating elements are provided on both sides of the heater plate, and heat conductive plates are installed on respective walls facing both the planar heating elements in the inflow passage and the outflow passage.

4. The headrest air-conditioning device according to claim 1, wherein a front inner surface of an outlet of the outflow passage is formed as a Coanda curved surface that serves to guide discharged air to an occupant's neck and shoulders.

5. The headrest air-conditioning device according to claim 1, wherein the heater plate consists of a plurality of heater plates installed at regular intervals in a front-and-rear direction of the casing to increase the number of passages, narrow a spacing between passages, and increase the number of heating surfaces.

6. The headrest air-conditioning device according to claim 1, wherein the heater plate has a plurality of backflow holes for allowing air to flow backward from downstream to upstream in a direction of flow thereof.

7. The headrest air-conditioning device according to claim 1, wherein the headrest air-conditioning device further comprises an outer casing surrounding the casing, a Helmholtz chamber is formed between the casing and the outer casing, and the casing has a plurality of Helmholtz holes formed on its front surface to allow the Helmholtz chamber to communicate with the outflow passage.

8. The headrest air-conditioning device according to claim 7, wherein the Helmholtz chamber is a single sealed space connecting the inner front and both sides of the outer casing.

9. The headrest air-conditioning device according to claim 7, wherein the casing has a plurality of noise emission holes formed on its rear surface, and the outer casing has a plurality of opening holes formed on its rear surface, so that noise within the casing is absorbed into a headrest cushion surrounding the outer casing through the noise emission holes and the opening holes.

10. The headrest air-conditioning device according to claim 1, wherein the casing is divided into a front casing and a rear casing.

11. The headrest air-conditioning device according to claim 10, wherein the rear casing has an intermediate part formed in its lower inner portion to partition an inlet of the inflow passage and an outlet of the outflow passage, and the intermediate part supports a lower end of the heater plate.

12. The headrest air-conditioning device according to claim 11, wherein the intermediate part has a plurality of partition walls formed in a width direction of the rear casing, and the lower end of the heater plate is supported by the partition walls.
